(19) United States
(12) Patent Application Publication
(10) Pub. No.: US 2005/0026769 A1
(43) Pub. Date: Feb. 3, 2005

(54) Process for SiBCN based preceramic polymers and products derivable therefrom

(76) Inventors: Jongsang Lee, Gainesville, FL (US); Ronald Howard Baney, Gainesville, FL (US)

Correspondence Address: AKERMAN SENTERFITT, P.O. BOX 3188, WEST PALM BEACH, FL, 33402-3188, US

(21) Appl. No.: 10/716,369

(22) Filed: Nov. 18, 2003

Related U.S. Application Data
(60) Provisional application No. 60/491,893, filed on Aug. 1, 2003.

(51) Int. Cl. C04B 35/00; C08G 77/26

(52) U.S. Cl. 501/96.2; 528/33; 528/38

(57) ABSTRACT

A method of forming SiBCN-based preceramic polymers or oligomers reacts a disilazane having the general formula (R₃Si)₂NH, where R is selected from the group consisting of vinyl, hydrogen, phenyl, and alkyls containing 1 to 3 carbon atoms with a boron halide including at least two halides, and a halosilane including at least two halogens at a temperature of between 125 C and 300 C. Upon partial pyrolysis, a partially pyrolyzed preceramic polymer or oligomer useful for burnable poison rod assemblies and spent fuel containers can be formed which provides hydrothermal stability and includes at least 3 wt % hydrogen.

### CROSS-REFERENCE TO RELATED APPLICATIONS

This application claims the benefit of U.S. Provisional Application No. 60/491,893 entitled “Process for SIBCN Based Preceramic Polymers” filed on Aug. 1, 2003, the entirety of which is incorporated herein by reference.

### STATEMENT REGARDING FEDERALLY SPONSORED RESEARCH OR DEVELOPMENT

The U.S. Government has certain rights to this invention pursuant to Grant/Contract No. #DE-FG07-011D-14117 from the Department of Energy (DOE).

### FIELD OF THE INVENTION

The invention relates organometallic polymers, and more specifically SiBCN based preceramic polymers and products derivable therefrom.

### BACKGROUND

Hydrosilazane based polymers can be prepared by the reaction of disilazanes, such as hexamethyldisilazane (HMDZ), with trichlorosilane (HSiCl₃). Such polymers are useful, when fired at high temperature, in the formation of silicon nitride and silicon nitride-containing ceramic materials. For example, U.S. Pat. No. 4,540,803 to Cannady discloses a process for preparing R₃SiNH-containing hydrosilazane polymers by contacting and reacting trichlorosilane with a disilazane [R₃Si]₂NH where R can be vinyl, hydrogen, phenyl or certain alkyls.

Organometallic polymers containing the elements of silicon, boron, carbon, nitrogen, and hydrogen, such as polyorganoborosilazanes, have been shown to have outstanding mechanical and chemical stabilities and to also be processable to form improved materials for high temperature applications. Boron is believed to provide enhanced thermal stability to SiCN-based materials. Such SiBCN organometallic polymers are precursors for ceramics including silicon nitride, silicon carbide, and boron nitride-based SiBCN ceramics. On the basis of their high strength and toughness, as well as on their thermal shock, corrosion and creep resistance, these ceramics provide a unique combination of properties with respect to high-temperature applications.

Boron carbide (B₄C) in an alumina matrix (Al₂O₃) is currently generally utilized for burnable poison rod assemblies (BPRA) and spent fuel containers (SFC). However there are at least two problems with use of (B₄C)/(Al₂O₃) compositions in these applications. First, a residual poison is present at end of cycle. Second, the composition displaces the moderating coolant in the guide tubes whose volume they occupy. Boron nitride-based SiBCN ceramic precursors do not have either of these problems and thus can be used to provide improved BPRAs, SFCs and related products.

Although processes exist for forming organometallic polymers containing the elements of silicon, boron, carbon, nitrogen, and hydrogen, the disclosed processes require multi-step, complex, and expensive processing for obtaining a homogeneous polymer having SiBCN components. Moreover, the resulting products tend to be impure. For example, polyborosilazane via the monomer route and polymer route shown in FIG. 1 is disclosed by Riedel et al. (“A Silicoboron Carbonitride Ceramic Stable to 2000 C”, Nature, vol. 382, 29, August 1996). Additional steps (not shown) beyond those shown in FIG. 1 are necessary in order to produce a crosslinked polymer structure. Moreover, either of the routes shown results in the polyborosilazane product being impure. Specifically, the polyborosilazane produced in the Riedel process undergoes hydrolysis during synthesis. Moreover, the synthesis does not efficiently eliminate reaction byproducts such as ammonium chloride, which leads to significant chlorine content mixed with the polyborosilazane in the form of ammonium chloride crystals.

### SUMMARY

A method of forming SiBCN-based preceramic polymers or oligomers comprises reacting a disilazane having the general formula (R₃Si)₂NH, where R is selected from the group consisting of vinyl, hydrogen, phenyl, and alkyls containing 1 to 3 carbon atoms, with a boron halide including at least two halogens, and a halosilane including at least two halogens. As used herein, the term “preceramic polymer” refers to a polymer or oligomer precursor which can be converted to a ceramic. The reaction is performed at a temperature of from about 125° C. to 300° C. The (R₃Si)₂NH can be (CH₃)₃SiNHSi(CH₃)₃. In one embodiment of the invention, the boron halide is BCl₃ while the halosilane is R₁SiCl₃, where R₁ is selected from the group consisting of vinyl, hydrogen, phenyl, and alkyls containing 1 to 3 carbon atoms.

The preceramic polymer or oligomer can be directly formed exclusively by the above-described reacting step. The chlorine content of the preceramic polymer or oligomer can be less than 100 parts per million. The preceramic polymer or oligomer can be substantially amorphous, as evidenced and defined herein by displaying no discernable X-ray diffraction peaks when X-ray diffraction is performed on the resulting preceramic polymer or oligomer.

The method can further comprise the step of partially pyrolyzing the SiBCN preceramic polymer or oligomer at a temperature of at least 300° C. in an inert atmosphere. The step of partially pyrolyzing the SiBCN preceramic polymer or oligomer is preferably performed at a temperature of between 400 and 600° C. Partially pyrolyzing a preceramic polymer or oligomer is believed to be an independently novel concept described herein as others have previously only fully pyrolyzed preceramic polymers to form ceramics. The partially pyrolyzed preceramic polymer or oligomer formed includes at least 3 wt % hydrogen, and preferably at least at least 4 wt %, and also provides hydrothermal stability. Although preceramic polymers generally include at least 3 wt % hydrogen, preceramic polymers are known to lack hydrothermal stability. Although ceramics provide hydrothermal stability, ceramics lack measurable hydrogen content. For nuclear applications, significant hydrogen content (e.g. at least 4 wt %) is necessary to absorb and slow down neutrons, while hydrothermal stability is required for the application conditions. Thus, partially pyrolyzed preceramic polymer or oligomers according to the invention provide both of these requirements for nuclear applications.

The method can also include the step of pyrolyzing the preceramic polymer or oligomer at a temperature that ranges from 700° C. to 1600° C. in an inert atmosphere. This step converts the preceramic polymer or oligomer into a ceramic.

A SiBCN-based preceramic polymer or oligomer comprises a silicon comprising backbone including boron and nitrogen, wherein the preceramic polymer or oligomer includes a plurality trialkylsilylamino groups. The trialkylsilylamino groups can be trialkylsilylamino, triarylsilylamino, trivinylsilylamino or hydridosilylamino groups.

A partially pyrolyzed SiBCN-based preceramic polymer or oligomer comprises a silicon comprising backbone including boron and nitrogen. The partially pyrolyzed SiBCN-based preceramic polymer or oligomer provides both hydrothermal stability and at least 3 wt % hydrogen. The % hydrogen is preferably at least 4 wt %. A burnable poison rod assembly (BPRA), comprising a bundle of control rods for insertion into a reactor core during refueling or a spent fuel container (SFC) for storing spent nuclear fuel can also be formed from the above described partially pyrolyzed preceramic polymer or oligomer.

### BRIEF DESCRIPTION OF THE DRAWINGS

A fuller understanding of the present invention and the features and benefits thereof will be accomplished upon review of the following detailed description together with the accompanying drawings, in which:

FIGS. 1(a) and (b) show a prior art polyborosilazane synthesis via a monomer and a polymer route and a new synthetic route for SiBCN based preceramic polymers and products, respectively.

FIG. 2 shows an exemplary structure of a SiBCN polymer or oligomer formed according to an embodiment of the invention.

FIG. 3 is a FT-IR spectrum of a preceramic polymer according to the invention which confirms the formation of various covalent bonds during synthesis.

FIG. 4 shows an IR spectra recorded on selected samples according to the invention.

FIG. 5 shows IR data demonstrating the elimination of reaction byproducts by condensation for a synthesis according to an embodiment of the invention.

FIG. 6 shows IR data which demonstrates the pyrolysis of a preceramic polymer according to the invention as a function of temperature.

FIGS. 7(a) and (b) show EDS data from an SiBCN polymer based on a prior art polymer and a preceramic polymer according to the invention, respectively.

FIG. 8 shows the compositional changes of a SiBCN polymer according to the invention after pyrolysis.

FIG. 9 shows a ²⁹Si-NMR spectrum of a preceramic polymer according to the invention which is consistent with the polymer structure shown in FIG. 4.

FIG. 10 shows ¹³C-NMR spectra of a preceramic polymer according to the invention which is consistent with the polymer structure shown in FIG. 4.

FIG. 11 shows ¹¹B-NMR spectrum of a preceramic polymer according to the invention which is consistent with the polymer structure shown in FIG. 4 demonstrating that all B atoms are bonded to N atoms.

FIG. 12 shows ¹H-NMR spectrum of a preceramic polymer according to the invention which is consistent with the polymer structure shown in FIG. 4.

FIG. 13 shows ¹⁵N-NMR spectrum of a preceramic polymer according to the invention which is consistent with the polymer structure shown in FIG. 4.

FIG. 14 is a TGA analysis of a preceramic polymer according to the invention which shows that the polymer to ceramic conversion occurs over the range 200-800° C., resulting in up to 71.7% ceramic yield.

FIG. 15 is a DSC analysis of a preceramic polymer according to the invention showing a Tg at 58° C., as well as large exothermic curves at near 300 and 500° C. which indicate the heat necessary for the molecules to arrange their structure by way of crosslinking and new bond formation.

FIG. 16 is an XRD pattern for a preceramic polymer formed according to the invention showing a broad featureless diffraction line at all ranges of 2θ, evidencing that a structural transformation has been retarded up to 1600° C.

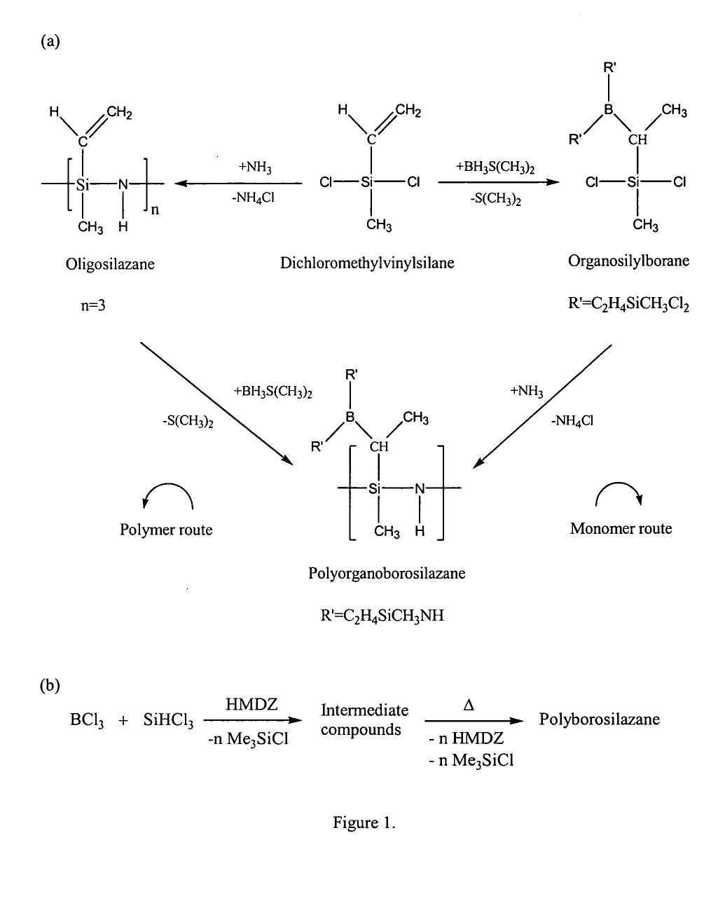

### DETAILED DESCRIPTION

A method of forming SiBCN-based preceramic polymers or oligomers includes the step of reacting a disilazane having the general formula (R₃Si)₂NH, where R is selected from the group consisting of vinyl, hydrogen, phenyl, and alkyls containing 1 to 3 carbon atoms with a boron halide including at least two halogens, and a halosilane including at least two halogens. An excess of the disilazane is generally provided. The reaction is generally performed at a temperature sufficient to drive off essentially all halogen atoms. For boron chloride and chlorosilane reagents tested, this temperature has been found to be from about 125° C. to 300° C.

The resulting preceramic polymer or oligomer product is an amorphous structure with crosslinked bonds formed from the elimination of byproducts having halogen (e.g. fluorine, chlorine, bromine, or iodine) atoms and from intermolecular condensation. No additional steps or additional reagents are required to initiate the crosslinking. The method is both simpler and less expensive as compared to other available methods for forming SiBCN-based preceramic polymers or oligomers. Moreover, the purity of the resulting preceramic polymer or oligomer product is enhanced.

In one exemplary embodiment of the invention, three monomers are reacted in a suitable solvent, such as hexane. In this preferred embodiment, RSiCl₃, where R is vinyl, hydrogen, phenyl and alkyls containing 1 to 3 carbon atoms is first mixed with boron halide having at least two halogens, such as boron trichloride. Subsequently the reaction is started by dropwise addition of a disilazane, such as hexamethyldisilazane. The mixture is then preferably heated to about 200° C. During synthesis with the above-described reagents, chlorine attached monomers are utilized so as to polymerize monomers by condensation reactions. The resulting product is an amorphous structure with crosslinked bonds formed during the elimination of byproducts having chlorine atoms and intermolecular condensation without the need for an additional step or additional reagents to initiate the crosslinking reaction. The resulting preceramic polymer or oligomer formed is generally insoluble in both polar and nonpolar organic solvents.

The SiBCN-based preceramic polymer or oligomer formed provides a novel structure. The structure comprises a silicon, boron and nitrogen backbone with numerous side-chains consisting of trialkylsilylamino groups. The trialkylsilylamino groups can be trialkylsilylamino, triarylsilylamino, trivinylsilylamino or hydridosilylamino groups.

The preceramic polymer or oligomer can optionally receive additional processing. The as-synthesized preceramic polymer or oligomer demonstrates significant compositional changes in the temperature range of from about 300 to 700° C. during partial pyrolysis and remains an amorphous ceramic structure up to about 1600° C., as demonstrated by X-ray diffraction data disclosed herein. At or above a temperature of about 1600° C., a ceramic is formed when small generally hydrogen-rich species, such as CH₄ have been evolved.

The available methods for synthesis of SiBCN preceramic polymers, such as disclosed by Riedel, require use of a crosslinking agent and subsequent pyrolysis. The method described herein does not require this added step for synthesis since it is in the form of a self-condensation reaction.

As noted above, in a preferred embodiment, polyborosilazane is obtained by reacting the monomers, such as boron trichloride (BTC) and trichlorosilane (TCS) with hexamethyldisilazane (HMDZ) via addition and condensation polymerization at a temperature of about 175-225° C.

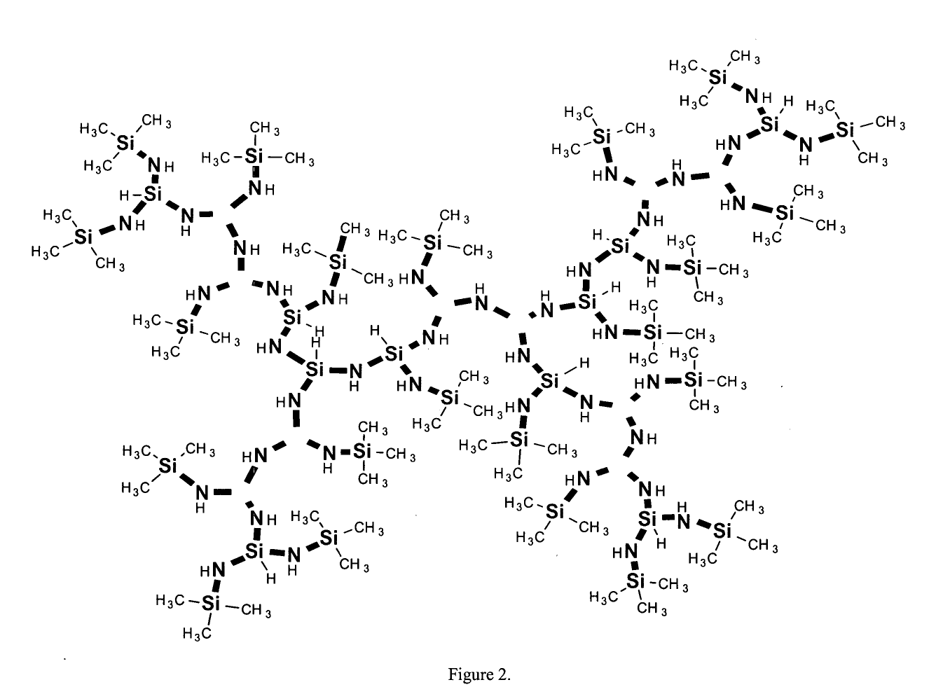

During synthesis at a low temperature, the reactor is full of low molecular weight oligomer clusters having a main chain C—Si—B—N sequence. By a slight further increase of the temperature to about 200° C., branching results and is accompanied by crosslinking. The reaction is accelerated by the liberation of HMDZ. It is estimated that the clusters in a bulky structure may form extended amorphous structure together with neighbor clusters. It is surprising that due to its high crosslinkage by intermolecular reactions, this polymer directly precipitates from the solution with a subsequent increase in the molecular weight of the product during the elimination of the byproducts by vacuum. As a result, a final product in the form of a white bulky powder is produced. FIG. 2 shows the proposed structure of the SiBCN polymer. The SiBCN polymer can then be pyrolyzed at a temperature of about 200 to 700° C.

The obtained weights of the extract and polymer powder with synthetic experiment trials are listed in Table 1. During synthesis, an effort was to prevent hydrolysis and to examine the reactivity by varying the initial feed content. At the same time, the elimination of byproducts was taken into account. PCP below stands for preceramic polymer or oligomer.

TABLE 1
The content of products and byproducts with experiments

| Item | PCP-1 | PCP-12 | PCP-13 | PCP-14 | PCP-15 | PCP-16 |
|---|---|---|---|---|---|---|
| Monomer feed content (g) | 30.8 | 30.8 | 46.2 | 46.2 | 46.2 | 46.2 |
| Product (g) | 3.0 | 2.8 | 4.0 | 4.6 | 3.4 | 3.1 |
| Byproduct (g)/yield (%) | 26.3/97.1 | 25.7/94.5 | 34.8/87.0 | 34.7/87.4 | 34.9/85.3 | 35.1/85.1 |

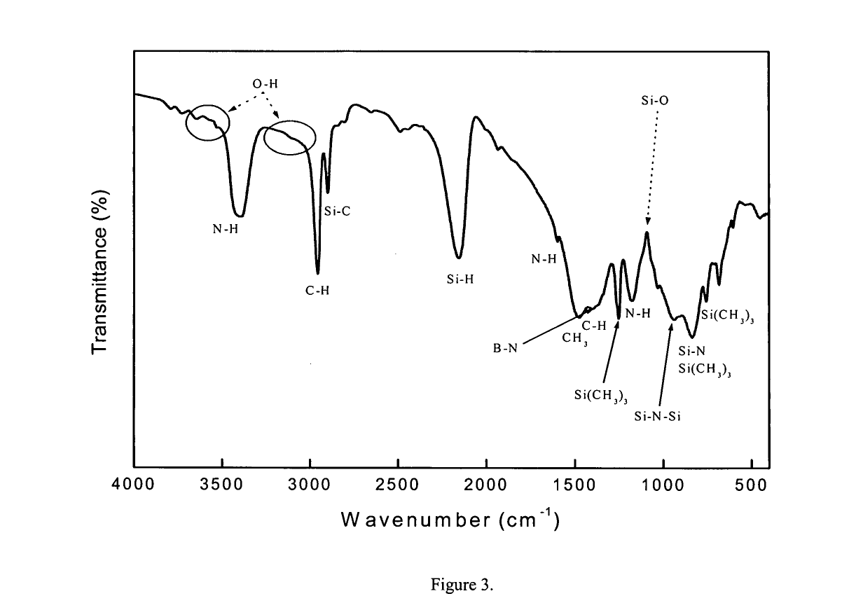

The FT-IR spectrum of the preceramic polymer shown in FIG. 3, confirms the formation of various covalent bonds formed during synthesis. Vibration bands of the N—H and Si—H units are observed at 3393 cm⁻¹, 1176 cm⁻¹ and 2156 cm⁻¹ respectively. A strong and broad vibration band overlapping with C—H group at 1403-1408 cm⁻¹ is centered at 1380 cm^{31 1} and refers to planar B−N unit—for pure hexagonal boron nitride a vibration band at 1347 cm⁻¹ has been reported. As expected, the sharp peaks at 2956 cm⁻¹ and 2899 cm⁻¹ appear separately and can be assigned to the formations of C—H bond and Si—C bond. In addition, the peaks are shown at 1252 cm⁻¹ due to Si—(CH₃)₃ bond from the chain end group in the structure, at 835 cm⁻¹ associated with a Si—N group attached to boron and at 940 cm⁻¹ due to a Si—N—Si bond derived from the intermolecular reaction between bulky clusters.

The formation of all bonds in the structure in FIG. 2 is verified and the peaks indicating hydrolysis of product are not shown in the IR spectra shown in FIG. 3. If hydrolysis of the product had occurred, a couple of broad and sharp peaks would be shown at around 3500 cm⁻¹ and at 1090 cm⁻¹ respectively.

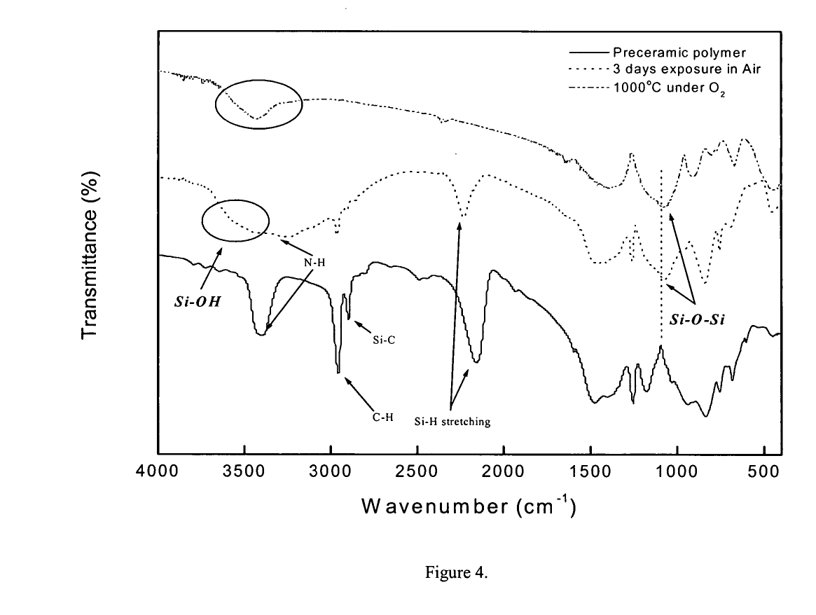

The overlapping between peaks makes the interpretation of an IR spectrum difficult. Therefore, the powder samples were compared after the deliberate hydrolysis of the product. First, one of the samples was obtained by leaving the preceramic polymer under a dry atmosphere for 3 days. The other sample experienced hydrolysis at high temperature under air. FIG. 4 shows the IR spectra recorded on selected samples. The greater the degree of hydrolysis of the preceramic polymer, the more intense the broadening of the peak at around 3500 cm⁻¹. This explains the formation of the bond units with silicon and hydroxyl group in the molecule. These samples exhibit a strong peak at 1090 cm⁻¹ region that may not be appeared in preceramic polymer, which indicates the formation of Si—O—Si bonds. As a result, it can be estimated that the preceramic polymer obtained from synthesis does not experience the hydrolysis.

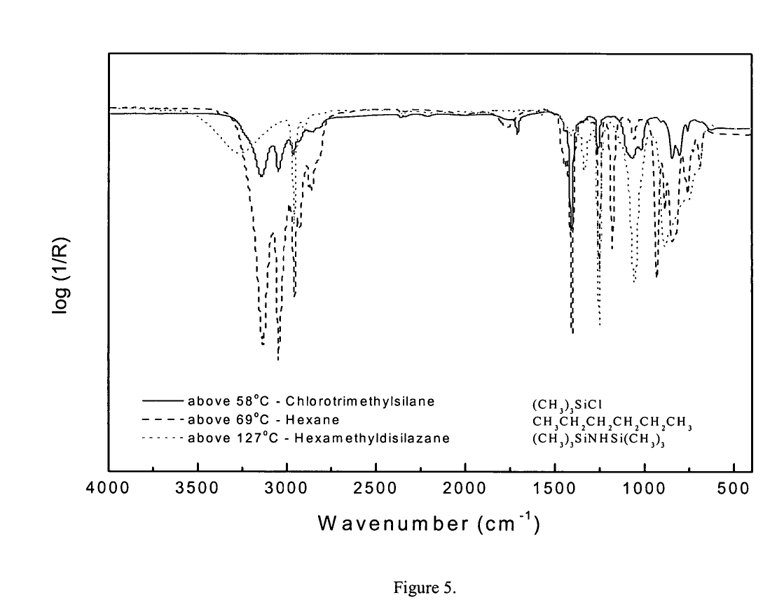

As mentioned above, byproducts can be eliminated by condensation without the need for any additional reagents. For example, when SiHCl₃ and HMDZ in a hexane solvent are used byproduct, solvent and unreacted chemicals can be removed through condensation at 58° C. as chlorotrimethylsilane, at 69° C. as hexane, and at 127° C. as hexamethyldisilazane, as shown in FIG. 5. The degree of reaction, as measure by molecular weight, is determined by the degree of volatile product elimination. To identify this elimination, a Schlenk-type glassware with stopcocks can be used in order to isolate products extracted from solutions as a function of temperature.

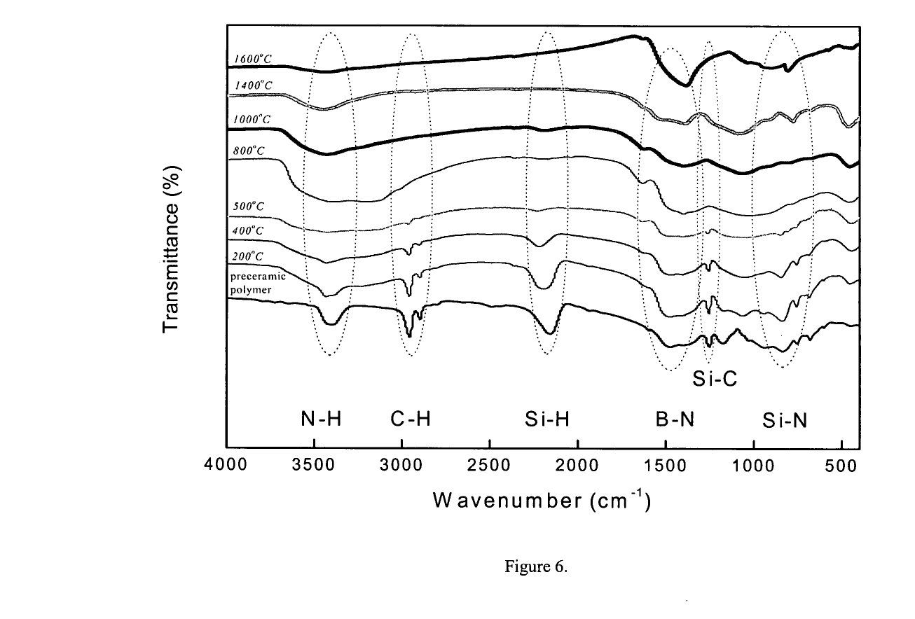

The pyrolysis of the preceramic polymer or oligomer with temperature is demonstrated by the IR data shown in FIG. 6. A strong peak at 1252 cm⁻¹ is assigned to Si—(CH₃) bond in the structure of chlorotrimethylsilane (ClSiMe₃). From the strong and sharp peak at 3000 cm⁻¹ assigned to alkane group, it is recognized that a large amount of hydrocarbon was eliminated. A strong peak at 1100 cm⁻¹ regions and peak broadening at 3400 cm⁻¹, may be explained as the elimination of molecules that reacted with trace amounts of oxygen among each monomer and the amino group in the molecule of hexamethyldisilazane.

With increasing temperature, the structural changes of pyrolyzed polymer were analyzed. An infrared study of the ceramic conversion process of the preceramic polymer revealed a stepwise loss of functional groups. From FIG. 6, at 200° C., the band of N—H is decreased relative to the Si—H and C—H absorptions. At 400° C., N—H band is further decreased, and the loss of Si—H and C—H begins. But at 500° C., both Si—H and C—H absorption bands are nearly absent. Peak broadening at 800° C. becomes evident near 3500 cm⁻¹. Similar results were observed in an infrared study of the pyrolysis of hydridopolysilazane polymers. Bulk pyrolysis of a preceramic polymer according to the invention above 1000° C. gave low ceramic yields (72%, 62%, and 53% at 1000° C., 1400° C, and 1600° C., respectively). Above 1400° C., the hydrogen bond connected to all of the atoms disappeared and, at high temperature ranges, it was evident that a Si—N bond appeared as a result of the elimination of B—N bond in main backbone with hexamethyldisilazane. Consequently, at temperatures above 1600° C., the transition phenomenon from amorphous to crosslinked crystalline structure having Si—C, B—N, and Si—N as the main bonds begins is believed to occur. This kind of structural change with temperature was analyzed by XRD.

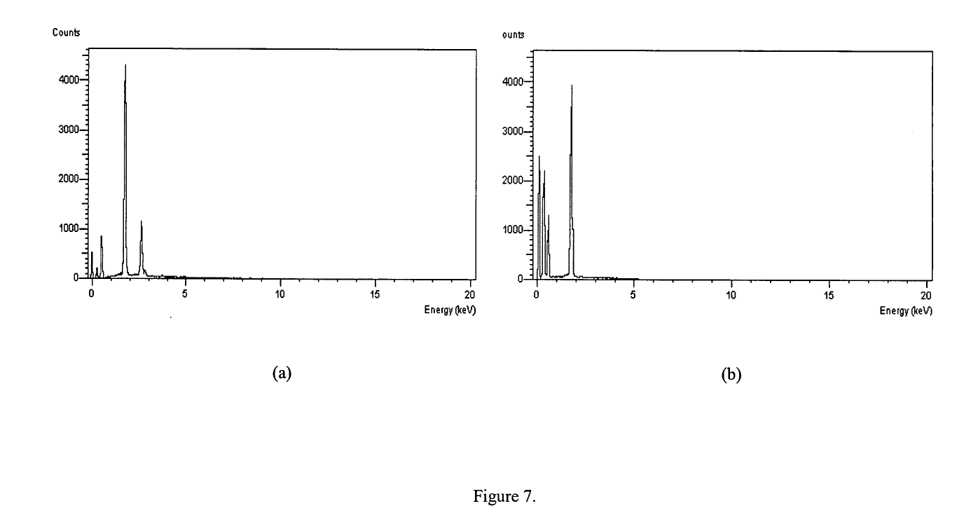

FIGS. 7(a) and (b) show EDS data from an SiBCN polymer based on Riedel and the invention, respectively. In general, since EDS analysis is a surface analytical method, it is not suitable for the determination of the quantity of components having low atomic number, such as B, C and even N. However, EDS can be utilized as a qualitative method to identify the specific components. In case of the Riedel polymer FIG. 7(a), a strong chlorine peak is shown at the position of 2.7 eV, whereas there is no discernable chlorine peak for the preceramic polymer according to the invention shown in FIG. 7(b).

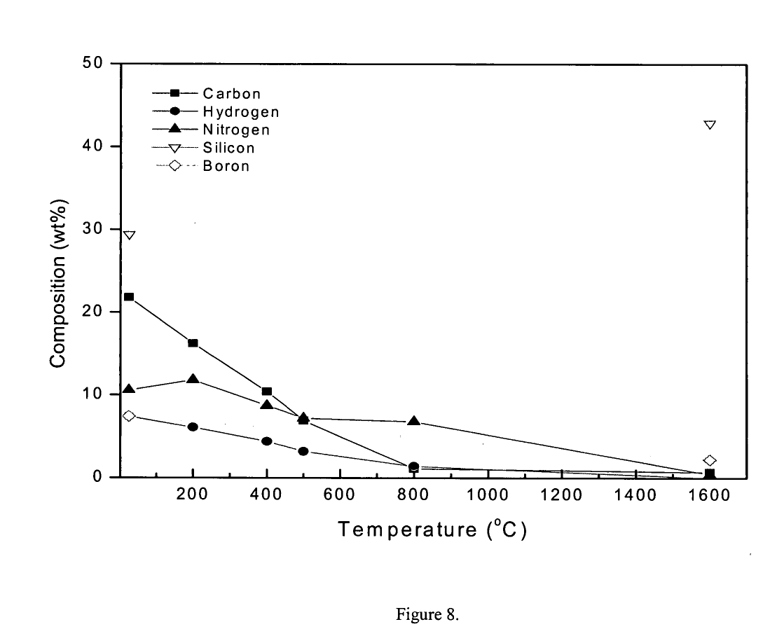

FIG. 8 shows the compositional changes of a SiBCN polymer according to the invention after pyrolysis. At room temperature, the chlorine content of preceramic polymer or oligomer is less than 500 ppm, such as less than about 100 ppm. Following processing at 200° C., or above, no chlorine was detected. Therefore, the inventive method efficiently removes byproducts, especially ammonium chloride, as confirmed by the above results.

A MAS-NMR analysis performed confirms the polymer structure shown in FIG. 2. Solid-state NMR spectroscopy can be used to determine the short-range order in amorphous phases. The structural information most frequently is derived from the chemical shifts and quadrupolar coupling constants (I>½ nuclei) of the individual nuclei, since these magnetic interactions depend directly on the actual molecular environment of the particular nucleus of interest.

For the preceramic polymer according to the invention that was examined, a series of nuclei—²⁹Si, ¹³C, ¹¹B, ¹H and ¹⁵N which are accessible can be used to probe the local order during synthesis. By this method, it can be determined how the structure of preceramic polymer or oligomer is formed.

1. ²⁹Si-NMR;

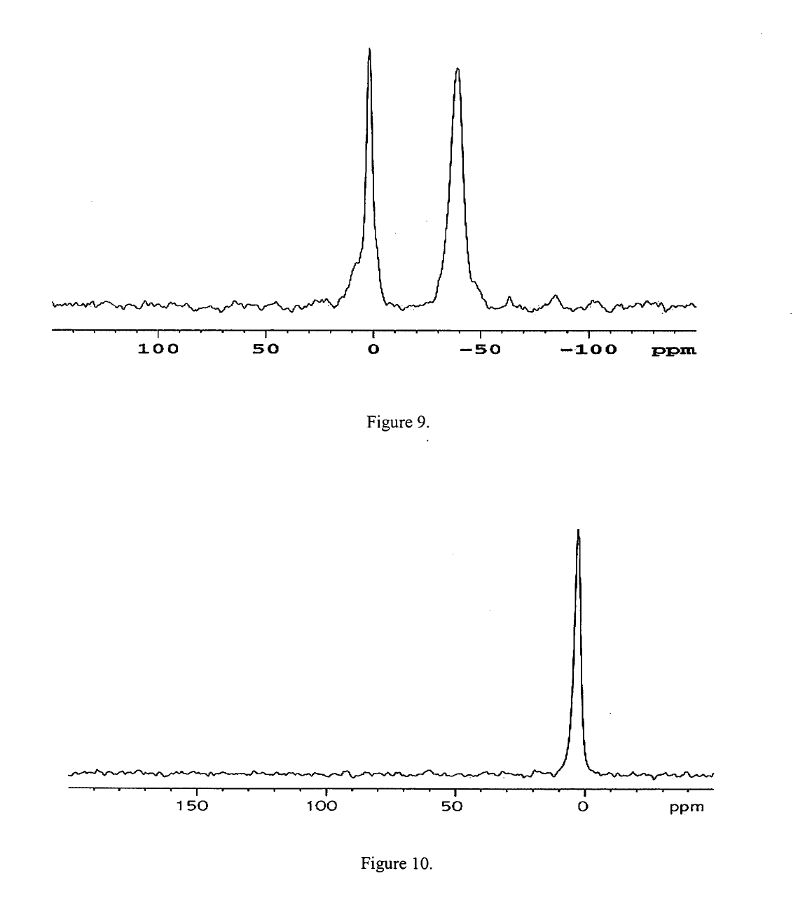

As can be seen in FIG. 9, the ²⁹Si-NMR spectrum of preceramic polymer is composed of a singlet at 2.0 ppm (Si—C₃) and at −39.3 ppm (Si—N₃) in a 1:1 integrated ratio, indicating there are two “kinds” of Si atoms in the structure. Silicon atoms are connected to the carbon (Si—C bond) and nitrogen crosslinked with another Si containing bulk chain (—Si—N—Si— bond).

2. ¹³C-NMR:

Experimental ¹³C-NMR spectra are given in FIG. 10. The spectrum of the preceramic polymer exhibits only one strong signal in the aliphatic region. This peak can be attributed to the Si—CH₃ group as expected. At near 60 ppm, small signal refer to noise or typical CH₂ group. But the existence of the latter might be nearly impossible because a CH₂-crosslinked bond is not desirable during the reaction.

3. ¹¹B-NMR

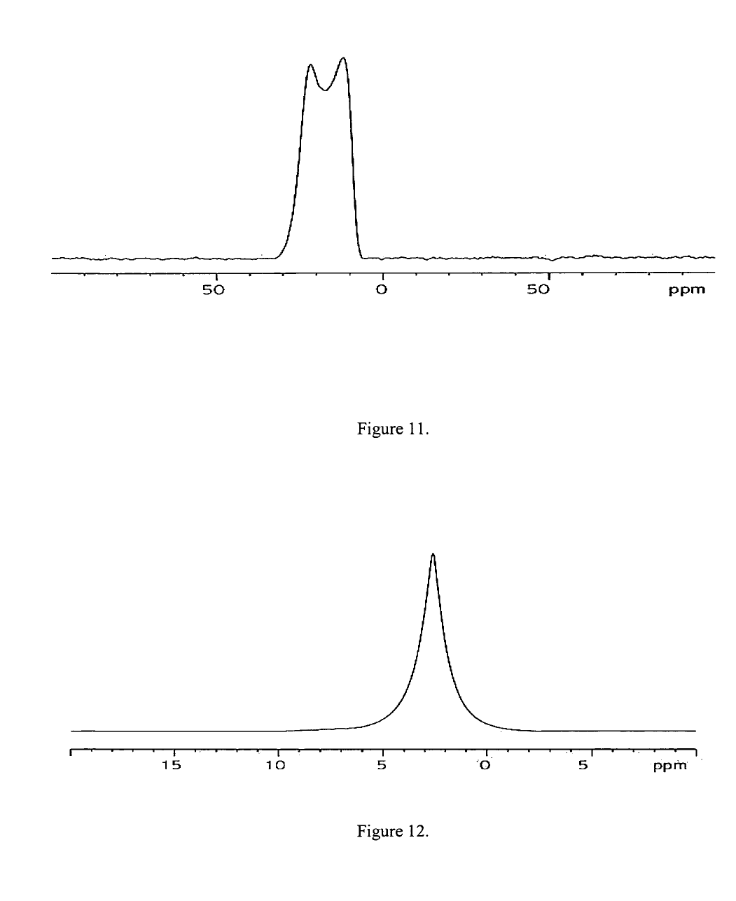

FIG. 11 shows the experimental ¹¹B-NMR spectrum. It is evident that in the reaction that only B—N bonds exist. Owing to the large quadrupolar moment of the boron nucleus, a second-order broadening is registered in the ¹¹B central transition NMR spectra, which cannot be eliminated by fast rotation at the magic angle. The preceramic polymer is typical for trigonally coordinated boron nuclei and are almost identical with the ¹¹B-NMR spectrum reported for hexagonal boron nitride. From the ¹¹B-NMR data, it is very unlikely that B—C bonds exist in the product not by attaching NH-site in hexamethyldisilazane to boron atom but by attaching CH₃-site in hexamethydisilazane molecule during reaction. The ¹¹B isotropic chemical shifts of BN₃, BN₂C and BC₃ sites thus typically range from 25 to 30 ppm, 30 to 35 ppm, and 65 to 85 ppm respectively. At the same time, the ¹¹B isotropic chemical shift value of below 30 ppm again fits with the value reported for hexagonal BN, i.e. BN₃ sites. Finally, it should be noted that the formation of BN domains is considered to be a prerequisite for the high-temperature stability of SiBCN ceramics, since BN domains serve as diffusion barriers and inhibit the decomposition reaction at higher temperatures.

4. ¹⁵H-NMR;

A representative ¹H-NMR spectrum is given in FIG. 12. As expected, proton NMR exhibits a relatively poor resolution due to the strong ¹H—¹H dipolar couplings. For the preceramic polymer, the slight signal at about 7 ppm is assigned to residual olefinic groups that did not react during the hydroboration step. The hydrogen bond in methyl group attached to silicon can be assigned to 2.4 ppm, even though hydrogen bonds exist in the silicon and nitrogen. Furthermore, it can be seen that ¹H-NMR absorption covers a broad spectral range around 1-5 ppm. That is, the various structural units in the amorphous preceramic polymer or oligomer material—assigned from the ²⁹Si, ¹³C and ¹¹B-NMR measurements—are also reflected by the ¹H-NMR spectra.

5. ¹⁵N-NMR;

Four types of nitrogen bonds in the structure of preceramic polymer such as Si—N—Si, HSi—N—B, Me₃Si—N—B and B—N—B are expected. Neither of the two nitrogen isotopes, ¹⁴N and ¹⁵N, are a particularly good NMR nucleus. Although ¹⁴N is abundant (99.63%), it is seldom used in solid-state NMR. The reasons are its small magnetogyric ratio and integer nuclear spin (I=1), which means that all transitions are broadened by the first-order quadrupole interaction. With typical ¹⁴N quadrupole interactions exceeding 1 MHz and with ¹⁴N relaxation times in the networks probably being comparable to the one in hexagonal boron nitride (more than 10 min), ¹⁴N-NMR appears to be quite demanding. To be able to observe the complete range of the nitrogen environment in the amorphous networks it is therefore necessary to use the isotope ¹⁵N. Because of its low natural abundance (0.02%), low magnetogyric ratio, and relaxation times in the range of hours, sensitivity is also low and no signal could be detected without isotopic enrichment even using half-integer quadrupole nuclei as a source for cross polarization (CP). So the polymer sample was very difficult to get distinguishable peak signals without using ¹⁵N enrichment.

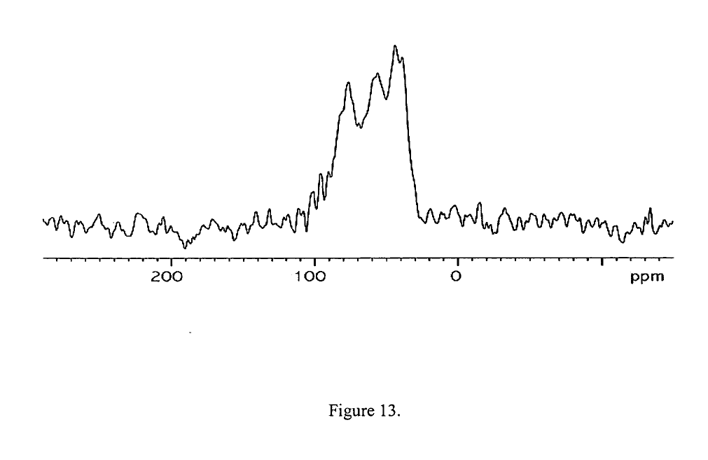

Since nitrogen enriched monomer (enriched HMDZ) is relatively expensive, the original monomer was used. FIG. 13 demonstrates signals using the non-enriched sample. A broad spectral component is visible in the downfield region at about 78.0 ppm. This is attributed to the formation of B—N—B and HSi—N—B units that can be seen as a similar spectral type—overlapping between two bonds—after the formation of crosslinked bond in the pyrolysis of hydroborated polyhydridovinylsilaze. It should be noted that ¹⁵N chemical shifts have been reported at 56.0 ppm and 41.0 ppm. These bands can be attributed to the formation of two kinds of bonds: Si—N—Si and Me₃Si—N—B, respectively.

In summary, the NMR spectra shown in FIGS. 9-13 are all consonant with the polymer structure shown in FIG. 2.

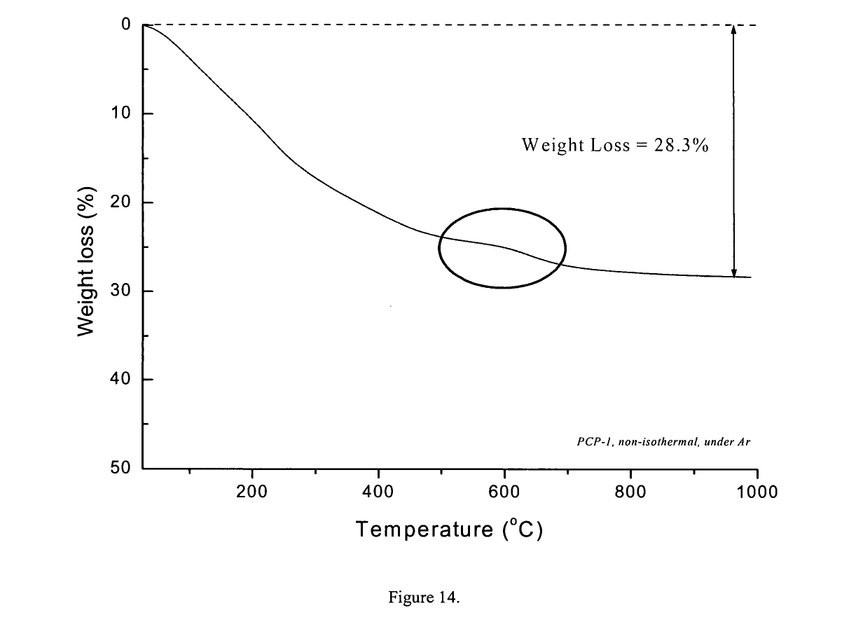

TGA analysis (FIG. 14) of the preceramic polymer formed from reacting the monomers BTC, TCS and HMDZ at 200° C. shows that the polymer to ceramic conversion begins to occur over the range 200-800° C., resulting in up to 71.7% ceramic yield. Although the ceramic yields vary with the specimen weight, the yield of preceramic polymer is similar to that of HPZ families. The initial weight loss observed at 100-300° C. could arise through a crosslinking reaction involving reaction with polymer backbone NH groups and Si—N linkages. It is interesting to note that the increase in the formation of Si—N bond compensates the slow decrease of weight loss at around 600° C. All the formations and decompositions of bonds in the structure are generally complete at approximately 800° C. No further weight loss occurs.

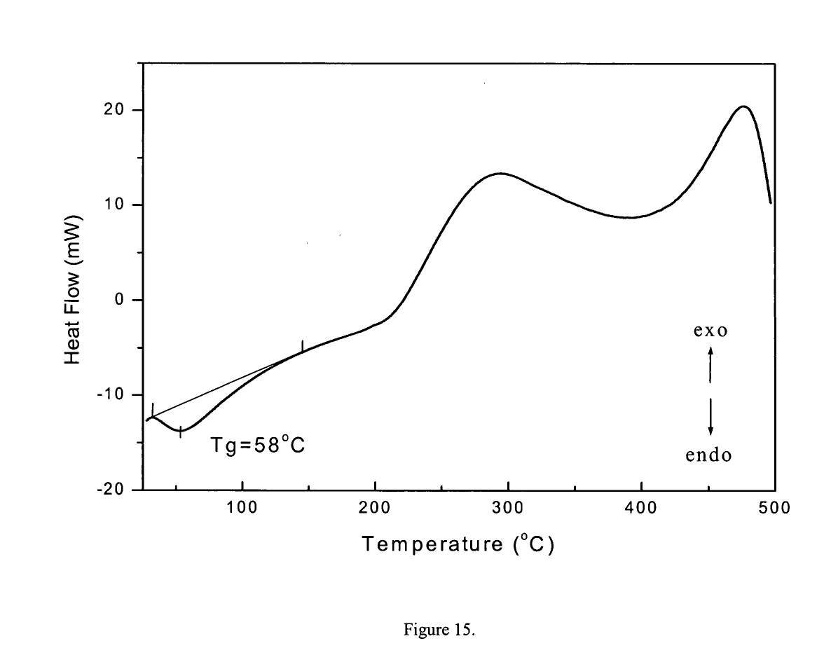

Consistent with the presence of a lower temperature crosslinking reaction, a DSC of the preceramic polymer in FIG. 15 showed an exothermal event near 300° C. Polymers according to the invention are similar to HPZ groups and have a glass transition temperature around 20-130° C. The polymer synthesized shows a Tg at 58° C. However, this polymer does not give typical single endothermic absorption curve that is shown in common polymers. Large exothermic curves at near 300 and 500° C. indicate the heat necessary for the molecules to arrange their structure by way of crosslinking and new bond formation.

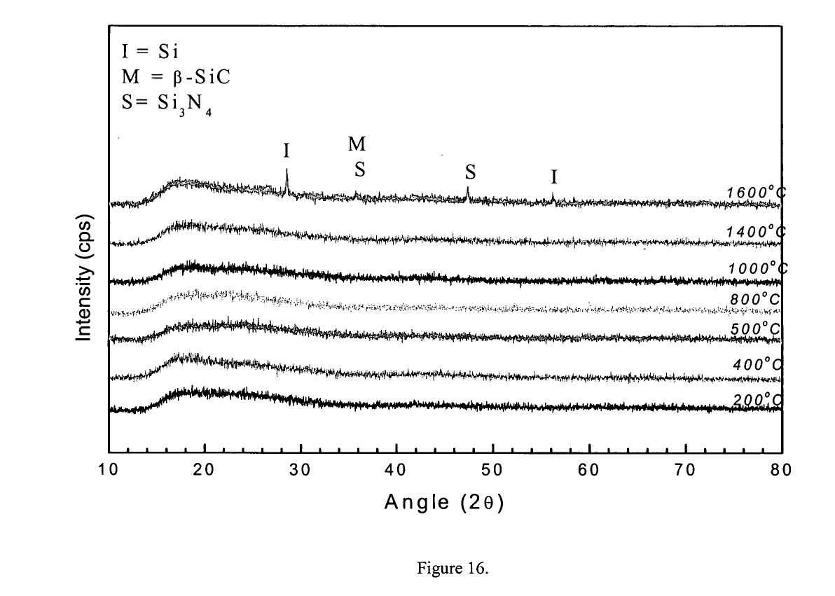

The XRD pattern (FIG. 16) for the polymer formed according to the invention shows a broad featureless diffraction line at all ranges of 2θ typical for amorphous phases, evidencing that structural transformation has been retarded up to 1600° C. The broad peak is attributed to the amorphous nature of the polymer. From this pyrolysis temperature, it can be assumed that the polymer initiates the crystallization owing to the appearance of tiny sharp peaks at 2θ=28°, 47°, and 56°.

Referring again to FIG. 8, the boron and hydrogen content of the preceramic polymer were 7.4 wt%. This amount is higher than the minimum effective hydrogen content of about 4 to 5% generally necessary for most nuclear field applications. It is known that the higher the boron content, the smaller the final grain size of the crystalline phase such as Si₃N₄ and SiC. The higher the boron content in the ceramics, the stronger the influence of the boron bonds on the resulting microstructure. The result of the BN(C) intergranular phase is a decrease of the mobility of the grain boundaries and a suppression of further crystal growth. The existence of boron atom leads to a stabilization of the amorphous state and shifts the temperature of crystallization of the thermodynamically stable phases to higher values. Thus, the existence of the single-phase amorphous state is extended to higher temperatures.

As the temperature increased, the decrease in the carbon concentration was much higher than nitrogen concentration. Both components existed as a low content at 1600° C. compared to the content of silicon and boron. An abrupt drop of carbon content at 800° C. indicates that carbon atoms at the end of the main chain were removed as gaseous products such as methane with the subsequent homolytic cleavage of Si—C bonds. Compared to this result, it can be concluded that the relatively small loss of nitrogen is due to the formation of a strong Si—N bond as described earlier.

Above 1600° C., the preceramic polymer begins to decompose with loss of nitrogen. Compositional change after pyrolysis is from SiB_{0.65}C_{1.74}N_{0.72}H₇ at room temperature to SiB_{0.19}C_{0.06}N_{0.03} at 1600° C.

Preceramic polymers and oligomers according to the invention can be used to produce improved articles for a variety of applications which require high temperature resistance and superior mechanical properties. For example, preceramic polymers and oligomers according to the invention can be used for ceramic matrix composites (CMCs) for light water reactors or other nuclear-related applications, such as burnable poison matrix material in burnable poison rod assemblies.

Embodied as an improved burnable poison rod assemblies (BPRA), the BPRA comprises a bundle of control rods for insertion into a reactor core during refueling. The rods include therein a SiBCN-based partially pyrolyzed SiBCN preceramic polymer or oligomer. As noted earlier, the SiBCN-based partially pyrolyzed SiBCN preceramic polymer or oligomer is formed by subjecting a preceramic polymer or oligomer according to the invention to a temperature of at least 300° C. in an inert atmosphere, wherein the resulting partially pyrolyzed preceramic polymer or oligomer includes at least 3 wt % hydrogen. As noted above, conventional BPRA materials (B₄C/Al₂O₃) have at least two problems, that is, the presence of a residual poison at end of cycle and the displacement of the moderating coolant in the guide tubes whose volume they occupy. Since the SiBCN partially pyrolyzed preceramic polymer or oligomer material according to the invention includes significant hydrogen, it will burn out more completely, reducing any residual negative reactivity at end of cycle and the water displacement penalty caused by burnable poison rod assemblies displacing moderator in the control rod guide tubes. The hydrogen provided by the SiBCN polymer also generally eliminates the moderator displacement reactivity penalty and provides hydrothermal stability without desolution in the event of clad failure.

In order to assess the potential of preceramic polymers according to the invention for nuclear applications where hydrothermal condition exist, autoclave testing was performed at 350° C., 3000 psi, and for 24 hours under water. Preceramic polymer powder was fabricated in the form of pellet to insert this into a holder in the autoclave. Subsequently, pyrolysis was performed on the pellet at 800° C. As described above relative to FIG. 14, the weight loss curve indicates little decomposition in the temperature range of about 600 to 1000 C. The data obtained from the autoclave testing is summarized in Table 2 below:

TABLE 2
ICP data for boron content after autoclave test

| Item | Data | |
|---|---|---|
| Pellet weight | 70 | mg |
| Boron content of pellet | 7.4 | wt % |
| Boron content in blank water | 0.76 | ppm |
| Boron content in effluent | 74.2 | ppm |
| Boron in the Autoclave | 1.1 | ppm |

| | |
|---|---|
| Boron effluent from polymer pellet | 0.02% |

Autoclave conditions: 350° C., 3000 psi, and 24 hours in water

After autoclave testing, two pellet samples, one was not pyrolyzed and the other was pyrolyzed at 800° C., did not hold their shapes in the autoclave. Nevertheless, the boron content of effluent dissolved from polymer pellet in water was very low, 200 ppm (=0.02%). Thus, polymers according to the invention can provide stability under severe conditions prototypic of a nuclear reactor.

### EXAMPLES

It should be understood that the examples and embodiments described herein are for illustrative purposes only and that various modifications or changes in light thereof will be suggested to persons skilled in the art and are to be included within the spirit and purview of this application. The invention can take other specific forms without departing from the spirit or essential attributes thereof.

1. Synthesis

All monomers were handled without air contact and maintained in a moisture-free environment. Boron trichloride (BTC), trichlorosilane (TCS), and hexamethyldisilazane (HMDZ) were used as starting materials. HMDZ is very reactive. Therefore the HMDZ was contained in hexane solvent. By using Schlenk-type glassware, hydrolysis of the product was prevented. Also, the inner part of the reactor was kept in an inert atmosphere. Before synthesis, the glassware was thoroughly cleaned and dried. Vacuum was applied into the reaction system to remove the residual air and the system was filled with nitrogen just before the addition of monomers.

The system can be divided into two parts, the reactor and condenser. Additional parts consist of the feed line for monomer initiation and a vacuum line for byproduct elimination. The bottles of chemicals were ordered to be equipped with septum. The injection into the reactor utilized a syringe to prevent contact with oxygen or water during transfers from bottles.

The process steps in an exemplary process performed were as follows. First, boron trichloride in a 1M-hexane solution was introduced into the syringe from the bottle. The proper amount was weighed on the balance and injected into the dropping funnel with septum. Trichlorosilane solution was added into the dropping funnel in the same manner. Because a sudden addition may give rise to precipitation among the reactants, it took several minutes by dropwise addition to achieve homogeneous solution without precipitate formation. At this time, the mixed solution became cloudy but no precipitation occurred. The possible influx of air during addition was eliminated by nitrogen charging (20 min) and the reactor was kept at room temperature. After mixing, HMDZ was added into mixed solution by way of dropwise addition. Since the addition of HMDZ may also cause precipitation, additional time was required to complete this process step. After all additions were added, nitrogen purging was performed for a limited time prior to heating.

In the first polymerization tried, the molar ratio between monomers was set at 1:1:4. (BTC/TCS/HMDZ). It was possible for this ratio to be changed after identification of the product properties. The reaction was initiated by adding heat slowly into the reactor. This allowed observation of the reactivity with varying temperature. Silicon oil was used as a heating medium. It was possible to observe the reactor through the transparent glass reactor while immersed in the silicon oil bath. The maximum temperature of the reactor was 200° C. At the boiling point (69° C.) of hexane, the reactor abruptly started boiling with deriving the extracts collected in a condensing device. To easily separate the byproducts, a column on the top of the reactor was wrapped with heat band to give high heat efficiency. Extracts removed from the reactor were gathered into the flask at various temperatures and identified by IR analysis. At maximum temperature reached, unreactive monomers and byproducts that remained in the reactor were removed by a vacuum pump. Vacuum was applied for several hours

After full elimination of liquid phase, the product was formed in the shape of a white bulky substance attached on the inner surface of the reactor. Nitrogen purge into the reactor containing bulk product was carried out again after removing heat up to room temperature. The bulk product was transferred into a glove box charged with nitrogen, ground in the mortar, put into the vial with nitrogen and stored in dry-seal desiccators.

2. Pyrolysis

Prior to pyrolysis, polymers were generally ground to a fine powder in a nitrogen atmosphere. Under various thermal treatments, the changes in the composition and the structure of the polymer were examined. Under 1000° C., polymer samples were pyrolyzed in thermal gravimetric analysis system/differential thermal analysis system (TGA/DTA). Pyrolysis was performed by heating from room temperature to a given temperature under nitrogen gas at a heating rate of 10° C./min, holding at a given temperature for an additional 60 min, and finally cooling at approximately 30° C./min to room temperature.

For heat treatments conducted at 1000° C. to 1600° C. a high temperature alumina tube furnace (Thermolyne 59300) was used. Initially, the furnace tube was flushed with high purity argon at room temperature. The condition of pyrolysis followed the same route as that used for pyrolysis below 1000° C. Polymer powder was spread over an alumina combustion boat to maximize the contact area with heat during pyrolysis. Subsequently, pyrolyzed polymer was stored in dry-seal desiccators under nitrogen-purged vial.

3. Characterization Conditions for Data Presented Above

1) IR (FIGS. 3-6)

FT-IR spectra were recorded with an OMNIC FT-IR Spectrometer. Diffuse-reflectance IR spectra (DRIFT), transmittance IR spectra, and attenuated total reflectance (ATR) IR spectra of the preceramic polymer powder and the extract were obtained by using a KBr pellet disc and liquid cell accessory kit. The IR spectra obtained from the DRIFT method did not give good resolution compared to other methods because of the color changes during the pyrolysis process. All experiments were performed under a slight nitrogen flow to prevent the hydrolysis during IR analysis.

2) NMR (FIGS. 9-13)

NMR experiments were carried out on 400 MHz Avance Bruker CXP 300 and MSL 300 spectrometers operating at a static magnetic field of 7.05 T using a 4.0 mm triple resonance probe. ²⁹Si, ¹³C, ¹¹B, ¹⁵N and ¹H-NMR experiments were done at 79 MHz, 100 MHz, 128 MHz, 41 MHz and 400 MHz respectively. ²⁹Si, ¹³C and ¹¹B-NMR spectra were recorded under MAS conditions (sample spin rate: 6.0 kHz) with either single pulse or cross polarization (CP) excitation, using π/2 pulse widths of 5 μs (²⁹Si, ¹³C and ¹¹B). 7.0 dB decoupling power was u in single pulse excitation experiments. During the CP experiments, contact times of 2 ms (²⁹Si, ¹³C and ¹¹B) were employed at recycle delays between 2 and 4 sec. The values of ²⁹Si and ¹³C chemical shifts were determined relative to external standards tetramethylsilane (TMS). ¹⁵N and ¹¹B chemical shifts were given relative to NH₄OH and H₃BO₃. ¹H—MAS NMR spectra were recorded at sample spinning rate of 12 kHz and single pulse excitation (π/2 pulse width of 4 μs) with a recycle delay of 2 s. The ¹H chemical shifts were directly referenced to TMS as external standard.

3) EDS (FIGS. 7(a) and 7(b))

The composition of preceramic polymer was examined by a JEOL JSM-6400 EDS. Polymer powder was carbon-coated in order to alleviate the random perturbation of the secondary electrons coming from preceramic powder in the vacuum chamber.

4) TGA & DSC (FIGS. 14 and 15, Respectively)

Thermogravimetric analysis (TGA) to 1000° C. and differential scanning calorimetry (DSC) to 500° C. were carried out using TA Instruments SDT 2050 to observe the weight loss kinetics and glass transition temperature of the preceramic polymer. The heating rate was 10° C./min. Argon was used as an inert atmosphere.

5) XRD (FIG. 16)

Changes in the structure of amorphous polymer and potential phase transformations at elevated temperatures were evaluated using a Philips APD 3720 XRD. The scanning angle (2θ) was 10-80° using monochromatic CuK_{α} radiation with a wavelength of λ/2=154.06 pm.

6) ICP (Table 2)

Elemental analyses were also performed. After autoclave testing, as described relative to Table 2, the dissolved boron content from the polymer was examined using inductively coupled plasma spectroscopy. This system was equipped with two monochromators covering the spectral range of 165-785 nm with a grated ruling of 3600 lines/mm. The ICP operates on the principle of atomic emission by atoms ionized in the argon plasma. Light of specific wavelengths is emitted as electrons return to the ground state of the ionized elements, quantitatively identifying the species present. The system is capable of analyzing materials in both organic and aqueous matrices with a detection limit range of less than 1 ppm. The concentration of the boron standard solution was 1000 ppm.

It should be understood that the examples and embodiments described herein are for illustrative purposes only and that various modifications or changes in light thereof will be suggested to persons skilled in the art and are to be included within the spirit and purview of this application. The invention can take other specific forms without departing from the spirit or essential attributes thereof.

1. A method of forming SiBCN-based preceramic polymers or oligomers, comprising the steps of:
reacting a disilazane having the general formula (R₃Si)₂NH, where R is selected from the group consisting of vinyl, hydrogen, phenyl, and alkyls containing 1 to 3 carbon atoms with a boron halide including at least two halogens and a halosilane including at least two halogens at a temperature of between 125° C. and 300° C., wherein a SiBCN preceramic polymer or oligomer is formed.

2. The method of claim 1, wherein said (R₃Si)₂NH is (CH₃)₃SiNHSi(CH₃)₃).

3. The method of claim 1, wherein said boron halide is BCl₃ and said halosilane is R₁SiCl₃, where R₁ is selected from the group consisting of vinyl, hydrogen, phenyl, and alkyls containing I to 3 carbon atoms.

4. The method of claim 1, wherein said preceramic polymer or oligomer is directly formed exclusively by said reacting step.

5. The method of claim 1, wherein a chlorine content of said preceramic polymer or oligomer is less than 100 parts per million.

6. The method of claim 1, wherein said preceramic polymer or oligomer is substantially amorphous.

7. The method of claim 1, further comprising the step of partially pyrolyzing said SiBCN preceramic polymer or oligomer at a temperature of at least 300° C. in an inert atmosphere, wherein a resulting partially pyrolyzed preceramic polymer or oligomer includes at least 3 wt % hydrogen.

8. The method of claim 7, wherein said step of partially pyrolyzing said SiBCN preceramic polymer or oligomer is performed at a temperature of between 400 and 600 C.

9. The method of claim 1, further comprising the step of pyrolyzing said preceramic polymer or oligomer at a temperature that ranges from 700° C. to 1600° C. in an inert atmosphere, wherein said preceramic polymer or oligomer is converted into a ceramic.

10. A ceramic formed from the process recited in claim 9.

11. A SiBCN-based preceramic polymer or oligomer, comprising:
a silicon comprising backbone including boron and nitrogen, wherein said preceramic polymer or oligomer includes a plurality trialkylsilylamino groups.

12. The polymer or oligomer of claim 11, wherein said trialkylsilylamino groups comprise a plurality of trialkylsilylamino, triarylsilylamino, trivinylsilylamino or hydridosilylamino groups.

13. The polymer or oligomer of claim 11, wherein a chlorine content of said preceramic polymer is less than 100 parts per million.

14. A partially pyrolyzed SiBCN-based preceramic polymer or oligomer, comprising:
a silicon comprising backbone including boron and nitrogen, wherein said partially pyrolyzed preceramic polymer or oligomer provides hydrothermal stability and includes at least 3 wt % hydrogen.

15. The partially pyrolyzed preceramic polymer or oligomer of claim 14, wherein said % hydrogen is at least 4 wt %.

16. A burnable poison rod assembly (BPRA), comprising a bundle of control rods for insertion into a reactor core during refueling, said rods including said partially pyrolyzed preceramic polymer or oligomer of claim 14.

17. A spent fuel container (SFC) for storing spent nuclear fuel, wherein said SFC is formed from said partially pyrolyzed preceramic polymer or oligomer of claim 14.
